(19) United States
(12) Patent Application Publication
(10) Pub. No.: US 2024/0256948 A1
(43) Pub. Date: Aug. 1, 2024

(54) INTELLIGENT ORCHESTRATION OF MULTIMODAL COMPONENTS

(71) Applicant: Microsoft Technology Licensing, LLC, Redmond, WA (US)

(72) Inventors: Leo Moreno BETTHAUSER, Kirkland, WA (US); William BLUM, Bellevue, WA (US); Andrew W. WICKER, Snoqualmie, WA (US); Eric Paul DOUGLAS, Kirkland, WA (US); Lloyd Geoffrey GREENWALD, Murray Hill, NJ (US); Nicholas BECKER, Boulder, CO (US)

(73) Assignee: Microsoft Technology Licensing, LLC, Redmond, WA (US)

(21) Appl. No.: 18/126,161

(22) Filed: Mar. 24, 2023

Related U.S. Application Data
(60) Provisional application No. 63/441,542, filed on Jan. 27, 2023.

(51) Int. Cl. G06N 20/00

(52) U.S. Cl. CPC G06N 20/00

(57) ABSTRACT

In some examples, a method for orchestrating an execution plan is provided. The method includes receiving an input embedding that is generated by a machine-learning model and receiving a plurality of stored semantic embeddings, from an embedding object memory, based on the input embedding. The plurality of stored semantic embeddings each correspond to a respective historic plan. Each historic plan includes one or more executable skills. The method further includes determining a subset of semantic embeddings from the plurality of stored semantic embeddings based on a similarity to the input embedding, and generating a new plan based on the subset of semantic embeddings and the input embedding. The new plan may be different than the historic plans that correspond to the subset of semantic embeddings. The method further includes providing the new plan as an output.

### CROSS-REFERENCE TO RELATED APPLICATION

This application claims priority to U.S. Provisional Application No. 63/441,542, titled “Intelligent Orchestration of Multimodal Components,” filed on Jan. 27, 2023, the entire disclosure of which is hereby incorporated by reference in its entirety.

### BACKGROUND

Computing devices may be relied on to perform any of a variety of different tasks. Further, computing devices may receive large quantities of content information, such as from user inputs, error logs, data transmissions, applications being executed, etc. Some systems may categorize and store the large quantities of content information that computing devices receive to compare related content objects (e.g., plans, skills, commands) for further processing. Further, some models may have the ability to follow sequential plans, such as security mitigation plans. However, such plans may not be newly generated, feasible (e.g., agent framework workstream), incorporate user feedback (e.g., feedback workstream), and/or avoid generating harm (e.g., responsible artificial intelligence workstream).

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to methods, systems, and media for orchestrating an execution plan. In some examples, an input embedding may be received. The input embedding may be generated by a machine-learning model, such as based on an intent or goal provided by a user. A plurality of stored semantic embeddings may further be received, such as from an embedding object memory, based on the input embedding. The plurality of stored semantic embeddings may each correspond to a respective historic plan and/or a respective historic input. Each historic plan may include one or more executable skills (e.g., executable skills that achieve a goal specified by an associated historic input). A subset of semantic embeddings may be determined from the plurality of stored semantic embeddings based on a similarity to the input embedding. The subset of semantic embeddings may be filtered based on metadata. A new plan may be generated based on the subset of semantic embeddings and the input embedding. The new plan may be different than the historic plans that correspond to the subset of semantic embeddings. The new plan may be provided as an output.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 illustrates an overview of an example system according to some aspects described herein.

FIG. 2 illustrates an example flow for retrieving information from an embedding object memory, according to some aspects described herein.

FIG. 3 illustrates an example flow for retrieving information from an embedding object memory, according to some aspects described herein.

FIG. 4 illustrates an example vector space, according to some aspects described herein.

FIG. 5 illustrates an example method for retrieving information from an embedding object memory, according to some aspects described herein.

FIGS. 6A and 6B illustrate overviews of an example generative machine learning model that may be used according to aspects described herein.

FIG. 7 illustrates a block diagram illustrating example physical components of a computing device with which aspects of the disclosure may be practiced.

FIG. 8 illustrates a simplified block diagrams of a computing device with which aspects of the present disclosure may be practiced.

FIG. 9 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As mentioned above, computing devices may be relied on to perform any of a variety of different tasks. Further, computing devices may receive large quantities of content information, such as from user inputs, error logs, data transmissions, applications being executed, etc. Some systems may categorize and store the large quantities of content information that computing devices receive to compare related content objects (e.g., plans, skills, commands) for further processing. Further, some models may have the ability to follow sequential plans, such as security mitigation plans. However, such plans may not be newly generated, feasible (e.g., agent framework workstream), incorporate user feedback (e.g., feedback workstream), and/or avoid generating harm (e.g., responsible artificial intelligence workstream).

An action space (e.g., agent environment) can be a static space composed of components and/or atomic actions. In some examples provided herein, the action space is modeled as a graph (e.g., an action space graph), where nodes are individual components (e.g., skills, dynamic prompts, or other smaller functions) and directed edges are added between two components. The output type of a first component (e.g., source component) may be an acceptable input type to a second component (e.g., target component). An execution plan may include a sequence of components which a model (e.g., a decoder model) desires to call. The execution plan may further include an order in which the sequence of components are to be resolved.

Valid execution plans may be subgraphs of the action space graph. Examples provided herein may dynamically evaluate historical execution plans and request new execution plans as context changes via component resolution and/or user feedback. Advantages of such examples may include personalization, a reduced number of calls to models (e.g., large language models), and/or or the ability to incorporate feedback compatible with the model.

In some examples, execution plans (e.g., subgraphs of the action space graph) can be evaluated based on feasibility, completeness, and/or responsibility criterion. Further, execution plans can be optimized without models having to necessarily regenerate a plan and incorporate user feedback by dynamic edge weight updates based on component responses. Such an ability provides for enhanced efficiency by reducing an amount of computational resources (e.g., processing power and/or memory) required to interact with the model.

In some examples, plans are generated by providing a prompt to a model which includes skills and/or a type of system. The model may then respond with a composition of skills in the form of an executable plan. Further in some examples, historical user requests and plans may be incorporated in generating new plans. For example, metadata may be used to filter to user aligned requests and/or linked tables may be used to explore plans to maximize relevance and stability.

Some examples provided herein include parsing a plan generated by a model (e.g., a large language model), encoding user requests with sentence transformers, encoding plans with sequence graph transformers, and/or building a request-plan linked embedding table. Some examples provided herein include encoding a user's request, applying a personalization filter, searching for highly ranked requests, requesting a plan-linked table lookup, ranking plans via a graph (e.g., the action space graph), returning a quantified ranking (e.g., in the form of [value, plan]), and/or injecting the plan into a prompt for a model.

In some examples, an execution plan's feasibility can be estimated by having the edge weights of the action space graph be conditioned on historical mitigations. Directed edges can be weighted based on the probability that the next component would follow the previous component as a part of a path or subgraph across all known mitigations (e.g., similar to a graphical model). In this way, any execution plan generated by a model can be associated with a probability, which can be a cost associated with its execution.

In some examples, each step of an execution plan will generate output, such as, for example, text output. The text output can be evaluated to determine whether to execute a subsequent step or modify an execution plan. For a set of sample inputs T, mechanisms provided herein can estimate a semantic alignment of an element t in T as an input to the next component (C) as follows: given a model M₀ (e.g., a large language model) compute a semantic encoding E_{T}=M₀(T); apply the component in question and apply another pretrained model M₁ to obtain a second embedding E_{C}(T)=M₁(C(T)); using supervised labels (e.g., user feedback) or unsupervised labels (e.g., cluster labels) perform outlier detection on the set of embeddings of component outputs E_{C}(T) to produce a mapping from the component outputs to the set of labels f:C(T)->L; pull back the assignment of each element of C(T) to an assignment on the original set of text T by looking at the preimage C⁻¹(C(T)) to obtain g:T->L; train a classifier to predict h:E_{T}->L such that if g(t)=1 then h(Eₜ)=1; and/or activate the next component only if the value of h(t) is an acceptable label with a degree of confidence beyond a specified threshold.

In some examples, models described herein can encode a given components output as an embedding. These models may be selected by each component's owner to encode the semantic meaning which is determined to best fit the owner's problem space. These representations can allow models to be trained to anticipate an expected value of a previous components model's output to yield meaningful output before applying the next component.

For embedding representations and/or label clustering described herein, any labels component owners may be used use to evaluate their own outputs or use an unsupervised method of clustering to generate labels for reasonableness of the output of the candidate component. Each skill's owner may choose a method to embed their output which may induce variance on the semantic relevance for the output data of their component. Once labels are established, the labels can be used to train a model (e.g., a lightweight model) over the output of the input component's embeddings to predict whether the input model's output is reasonable to send to a downstream component.

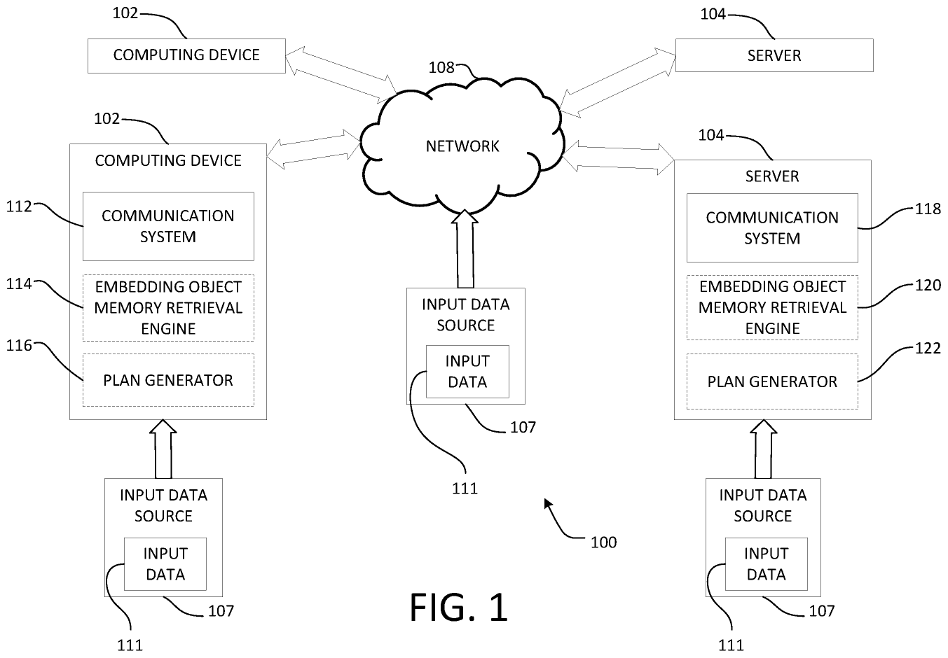

FIG. 1 shows an example of a system 100, in accordance with some aspects of the disclosed subject matter. The system 100 may be a system for using an embedding object memory, such as by retrieving information from the embedding object memory. The system 100 includes one or more computing devices 102, one or more servers 104, an input data source 107, and a communication network or network 108.

The computing device 102 can receive input data 111 from the input data source 107, which may be, for example, a camera, a microphone, a computer-executed program that generates input data, and/or memory with data stored therein corresponding to input data. The content data 111 may be, for example, a user-input, such as a voice query, text query, etc., an image, an action performed by a user and/or a device, a computer command, a programmatic evaluation, or some other input data that may be recognized by those of ordinary skill in the art. Additionally, or alternatively, the network 108 can receive input data 111 from the input data source 107.

Computing device 102 may include a communication system 112, an embedding object memory retrieval engine or component 114, and/or a plan generator 116. In some examples, computing device 102 can execute at least a portion of the embedding object memory retrieval component 114 to retrieve a plurality of stored embeddings from an embedding object memory, based on an input embedding (e.g., generated based on the input data 111). For example, a subset of embeddings may be retrieved from the plurality of stored embeddings, based on a similarity to the input embedding.

In some examples, computing device 102 can execute at least a portion of the plan generator 116 to generate a plan based on a subset of semantic embeddings from the plurality of stored embeddings that were retrieved. For example, the plan may be similar to one or more historical plans that are associated with one or more semantic embeddings from the subset of semantic embeddings. In some examples, the plan may include one or more executable skills that are determined based on one or more executable skills of the historical plans and the input data 107.

Server 104 may include a communication system 118, an embedding object memory retrieval engine or component 120, and/or a plan generator 122. In some examples, server 104 can execute at least a portion of the embedding object memory retrieval component 120 to retrieve a plurality of stored embeddings from an embedding object memory, based on an input embedding (e.g., generated based on the input data 111). For example, a subset of embeddings may be retrieved from the plurality of stored embeddings, based on a similarity to the input embedding.

In some examples, server 104 can execute at least a portion of the plan generator 122 to generate a plan based on a subset of semantic embeddings from the plurality of stored embeddings that were retrieved. For example, the plan may be similar to one or more historical plans that are associated with one or more semantic embeddings from the subset of semantic embeddings. In some examples, the plan may include one or more executable skills that are determined based on one or more executable skills of the historical plans and the input data 107.

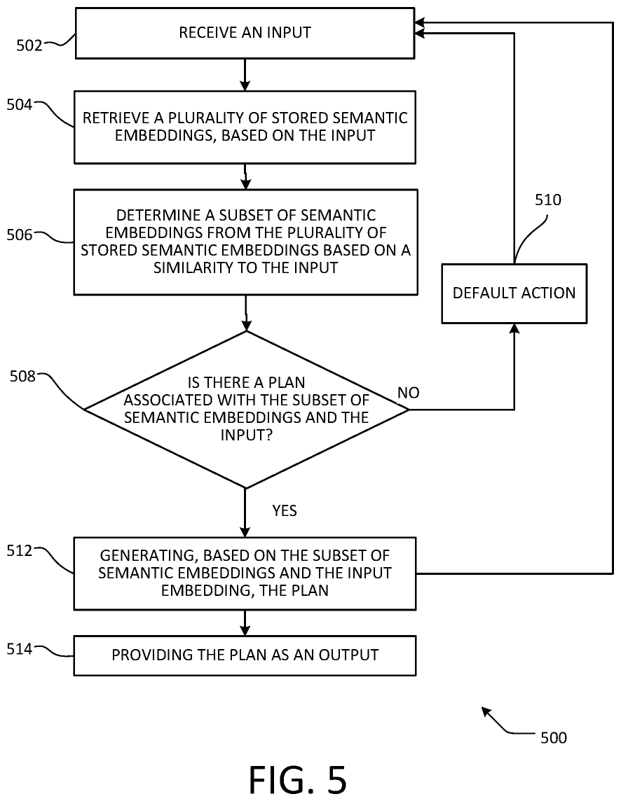

Additionally, or alternatively, in some examples, computing device 102 can communicate data received from input data source 107 to the server 104 over a communication network 108, which can execute at least a portion of the embedding object memory retrieval component 114 and/or the plan generator 116. In some examples, the embedding object retrieval component 114 and/or 120 may execute one or more portions of method/process 500 described below in connection with FIG. 5. Further in some examples, the plan generator 116 and/or 122 may execute one or more portions of method/process 500 described below in connection with FIG. 5.

In some examples, computing device 102 and/or server 104 can be any suitable computing device or combination of devices, such as a desktop computer, a vehicle computer, a mobile computing device (e.g., a laptop computer, a smartphone, a tablet computer, a wearable computer, etc.), a server computer, a virtual machine being executed by a physical computing device, a web server, etc. Further, in some examples, there may be a plurality of computing device 102 and/or a plurality of servers 104. It should be recognized by those of ordinary skill in the art that input data 111 may be received at one or more of the plurality of computing devices 102 and/or one or more of the plurality of servers 104, such that mechanisms described herein can generate plans based on the input data 111 and an embedding object memory.

In some examples, input data source 107 can be any suitable source of input data (e.g., a microphone, a camera, a sensor, etc.). In a more particular example, input data source 107 can include memory storing input data (e.g., local memory of computing device 102, local memory of server 104, cloud storage, portable memory connected to computing device 102, portable memory connected to server 104, privately accessible memory, publicly-accessible memory, etc.). In another more particular example, input data source 107 can include an application configured to generate input data. In some examples, input data source 107 can be local to computing device 102. Additionally, or alternatively, input data source 107 can be remote from computing device 102 and can communicate input data 111 to computing device 102 (and/or server 104) via a communication network (e.g., communication network 108).

In some examples, communication network 108 can be any suitable communication network or combination of communication networks. For example, communication network 108 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some examples, communication network 108 can be a local area network (LAN), a wide area network (WAN), a public network (e.g., the Internet), a private or semi-private network (e.g., a corporate or university intranet), any other suitable type of network, or any suitable combination of networks. Communication links (arrows) shown in FIG. 1 can each be any suitable communications link or combination of communication links, such as wired links, fiber optics links, Wi-Fi links, Bluetooth links, cellular links, etc.

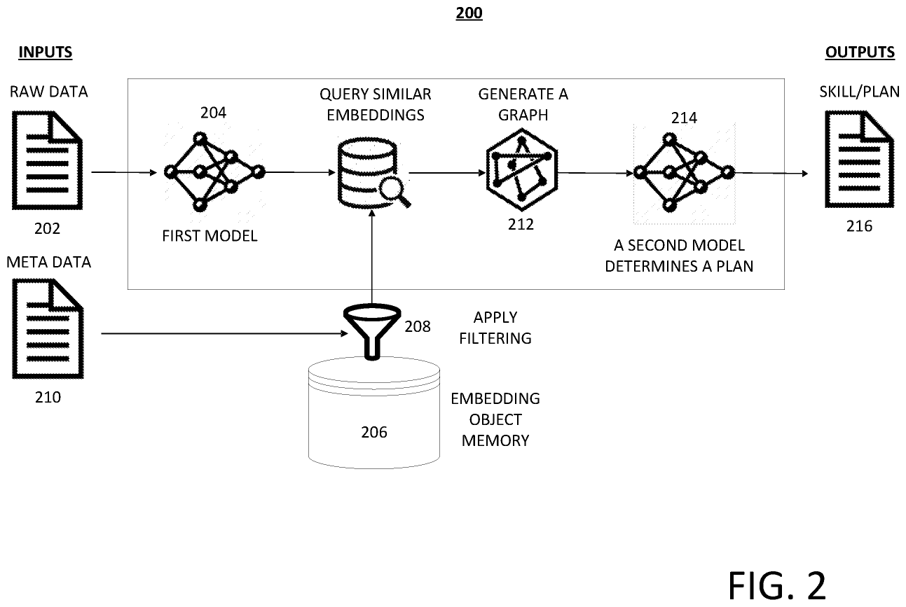

FIG. 2 illustrates an example flow 200 of retrieving information from an embedding object memory, according to some aspects described herein. An input 202 may be received at a first model 204 (e.g., an encoder model). The input 202 may be a user-input or a machine-generated input. Additionally, or alternatively, input 202 may be similar to one or more aspects of the input data 111 described earlier herein with respect to FIG. 1. The first model 204 may generate an embedding based on the input 202. The generated embedding may be a semantic embedding.

A plurality of stored embeddings 206 may be stored in an embedding object memory. The embedding object memory that stores the stored embeddings 206 may be a database, or a repository, or a tree, or a vector space, or another type of data structure that may be recognized by those of ordinary skill in the art.

Embeddings, from the plurality of embeddings 206, may be queried that are similar to the input embedding generated by the model 204. In some examples, before being queried based on similarity, a filtering 208 may be applied to the plurality of embeddings 206, based on metadata 210. The filtering 208 may be a personalization to at least one of a user or organization. For example, the personalization may be based on the metadata 210.

In some examples, the plurality of embeddings 206 may be filtered based on the personalization. For example, if the metadata 210 indicates that a specific skill is not desirable, then embeddings associated with historic plans that contain the specific skill may be filtered out (e.g., not included in the queried embeddings). Conversely, if the metadata 210 indicates that a specific skill is highly desirable, then embeddings associated with historic plans that contain the specific skill may be included in the queried embeddings that are similar to the input embedding.

In some examples, the metadata 210 is associated with compliance requirements for security. The compliance requirements may be specified by the user and/or the organization to which the embeddings are personalized (e.g., by the filtering 208). For example, the metadata 210 may adapt the queried embeddings from the plurality of embeddings 206 to include only embeddings whose associated plans are determined to be good (e.g., executed in compliance with specific security protocols). In some examples, the metadata 210 may adapt the queried embeddings to include embeddings whose associated plans are determined to be stable within a requisite degree for measuring stability.

After being queried for similarity, a graph or metric graph or action space graph 212 may be generated based on the queried embeddings and the input embedding. In some examples, the input embedding and each embedding of the queried embeddings are stored in a metric graph as nodes. A respective edge of the metric graph may be defined between the input embedding and each embedding of the queried embeddings. Each edge may be associated with a respective cost or weight (e.g., calculated similarities between the embeddings).

At a second model 214, a plan 216 is determined based on the generated graph 212. For example, the plan 216 may include one or more skills based on costs associated with traversing between different nodes of the graph 212. Accordingly, subgraphs of the graph 212 may be determined that include associated costs or weights. The plan 216 may include the subgraph of the graph 212 with the associated cost or weight. In some examples, the first model 204, the graph 212, and the second model 216 may be configured in an online mode (e.g., executed and/or stored on a server device). For example, the input 202 may be received online at the first model 204, similar embeddings may be queried online, the graph 212 may be generated online, and/or the second model 214 may determine the plan 216 online.

The plan 216 may be output for further processing. For example, the plan 216 may be output to a user and the user may provide feedback based on the plan 216. Additionally, or alternatively, one or more aspects of the plan 216 may be executed automatically by a system (e.g., system 100 discussed with respect to FIG. 1).

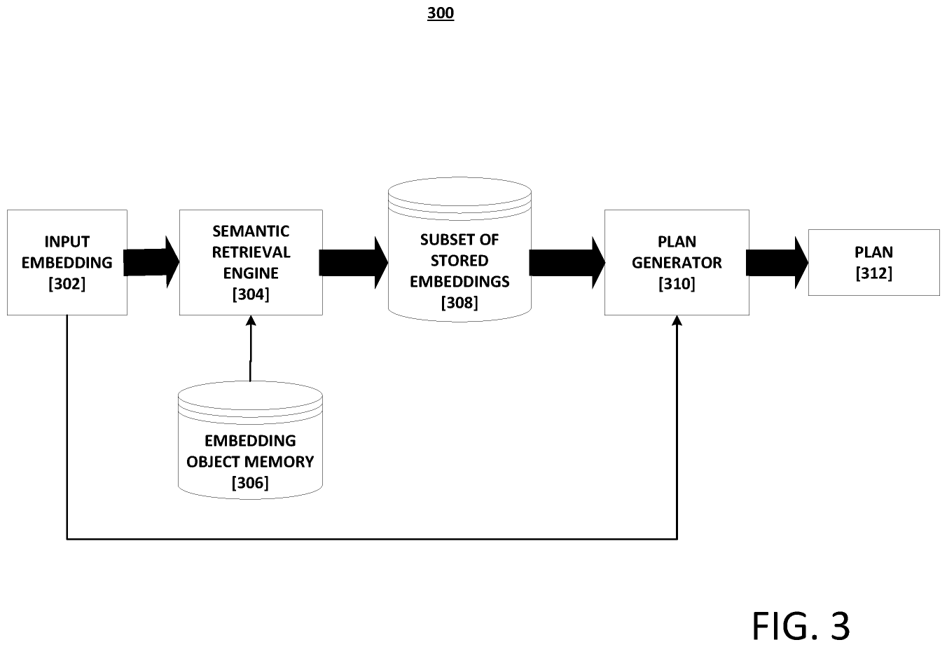

FIG. 3 illustrates an example flow 300 for retrieving information from an embedding object memory, according to some aspects described herein. The example flow begins with receiving an input embedding 302. The input imbedding 302 may be generated by a model, such as a machine-learning model. For example, user-input may be received by a system and the user-input may be input into an embedding generator. The input embedding 302 may correspond to an intent of a user. For example, a user may intend to diagnose a specific security issue. Therefore, the input embedding 302 may correspond to a prompt that would be provided to a security analyst, such as to resolve a security threat. Additional and/or alternative intents that a user has with respect to a computing device may be recognized by those of ordinary skill in the art.

In some examples, the input embedding 302 may be generated based on something other than user-input. For example, the input embedding 302 may be generated based on an algorithm that triggers the input embedding 302 to be generated. Additionally, or alternatively, the input embedding 502 may be generated based on an audio and/or visual input that is received by a computer (e.g., independent from user-input). In some example, the input embedding 302 may be generated by a natural language processor, or a visual processor, or a generative large language model. Additional and/or alternative methods for generating the input embedding 302 may be recognized by those of ordinary skill in the art.

The input embedding 302 may be input into a semantic retrieval engine 304. The semantic retrieval engine or component 304 may include hardware and/or software that retrieves, from a embedding object memory 304 (e.g., which may be similar to the embedding object memory provided by method 500), a subset of stored embeddings. For example, the embedding object memory 306 may store a plurality of embeddings from which the subset of stored embeddings are determined. One or more of the plurality of stored embeddings may correspond to historical plans and/or historic input (e.g., user-input), such as may be associated with respective historic plans. Further, the plurality of embeddings may each be semantic embeddings.

A subset of stored embeddings 308 may be retrieved from the embedding object memory 306 (e.g., by the semantic retrieval engine 304). The subset of stored embeddings 308 may be determined based on a similarity to the input embedding 302, For example, the embeddings may correspond to plans associated with historical input and if a specific historical input is determined to be semantically similar to the input from which the input embedding 302 was generated, then the embedding associated with the specific historical input may be determined to be part of the subset of stored embeddings 308. It is noted that the embedding associated with the specific historical input may also have an associated historical plan from which a new plan may be generated based thereon.

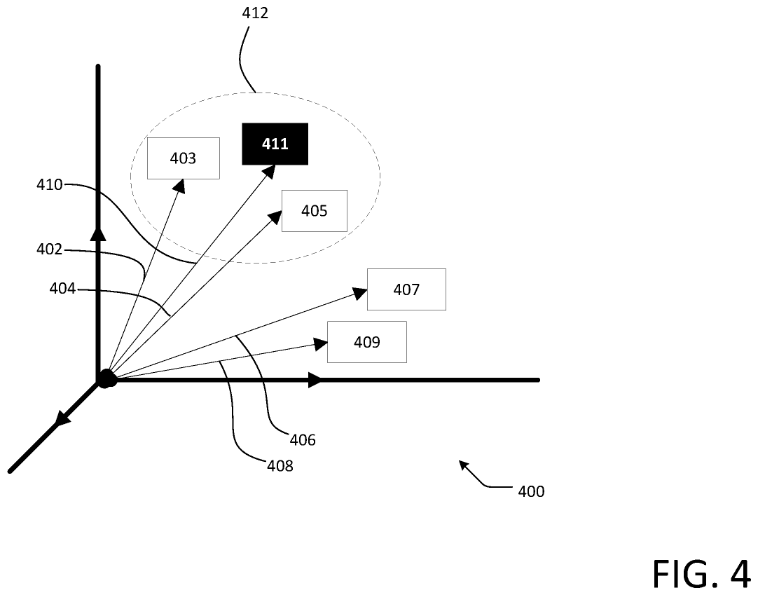

Mechanisms for determining a similarity of embeddings to the input embeddings are discussed in further detail with respect to the vector space 400 of FIG. 4. In some examples, an ordered ranking of the similarities may be determined. For example, the similarities may be ordered (e.g., in an increasing or decreasing fashion) based on values (e.g., costs) associated with the determined similarities. Therefore, the subset of stored embeddings 308 may be retrieved based on the ordered ranking (e.g., a specified number of top and/or bottom rankings may be retrieved). In some examples, a subset of semantic embeddings may be retrieved with similarities to the input embedding that are less than the predetermined threshold and/or based on the ordered ranking.

At plan generator 310, a plan or executable plan 312 is generated based on the subset of stored embeddings 308. Further, the plan 312 may be generated based on the input embedding 302. For example, the plan may be generated based on historic plans and/or historic inputs associated with the subset of stored embeddings 308. In some examples, the plan 312 may be a new plan that is different from each historic plan associated with the subset of stored embeddings 308. The plan 312 may include one or more skills. One or more skills of the plan 312 may be similar to one or more skills of the historic plans. In some examples, the plan 312 includes instructions that, when executed by a computing device, cause a set of operations to be performed (e.g., automatically) that correspond to the one or more skills.

FIG. 4 illustrates an example vector space 400 according to some aspects described herein. The vector space 400 includes a plurality of feature vectors, such as a first feature vector 402, a second feature vector 404, a third feature vector 404, a fourth feature vector 408, and a fifth feature vector 410. Each of the plurality of feature vectors 402, 404, 406, and 408 correspond to a respective embedding 403, 405, 407, 409 generated based on historical information (e.g., historic plans, historic inputs, and/or executable skills). The embeddings 403, 405, 407, and 409 may be semantic embeddings. The fifth feature vector 410 is generated based on an input embedding 411. The embeddings 403, 405, 407, 409 may be similar to the embeddings stored in the embedding object memory 306, discussed with respect to FIG. 3. The input embedding 411 may be similar to the input embedding 302.

The feature vectors 402, 404, 406, 408, 410 each have distances that are measurable between each other. For example, a distance between the feature vectors 402, 404, 406, and 408 and the fifth feature vector 410 corresponding to the input embedding 411 may be measured using cosine similarity. Alternatively, a distance between the feature vectors 402, 404, 406, 408 and the fifth feature vector 410 may be measured using another distance measuring technique (e.g., an n-dimensional distance function) that may be recognized by those of ordinary skill in the art.

A similarity of each of the feature vectors 402, 404, 406, 408 to the feature vector 410 corresponding to the input embedding 411 may be determined, for example based on the measured distances between the feature vectors 402, 404, 406, 408 and the feature vector 410. The similarity between the feature vectors 402, 404, 406, 408 and the feature vector 410 may be used to group or cluster the feature vectors 402, 404, 406, and 408 in one or more collections of feature vectors, such as a collection 412, thereby generating a collection or subset of embeddings.

In some examples, the collection 412 may include a predetermined number of feature vectors, such that groups of feature vectors are given a predetermined size. Additionally, or alternatively, in some examples, the distances between each of the feature vectors 402, 404, 406, 408 and the feature vector 410 corresponding to the input embedding 411 may be compared to a predetermined threshold.

The embeddings 403 and 405 that correspond to feature vectors 402 and 404, respectively, may correspond to similar historic plans. For example, the embedding 403 may be related to a historic plan containing a first skill, a second skill, and a third skill, and the embedding 405 may be related to a historic plan containing the first skill, the second skill, and a fourth skill. The skills may each include or correspond to a set of instructions that when executed by a computing device cause a set of operations to be performed corresponding to one or more of the skills.

The collection 412 may be stored in a data structure, such as a metric graph, an ANN tree, a k-d tree, an octree, another n-dimensional tree, or another data structure that may be recognized by those of ordinary skill in the art that is capable of storing vector space representations. Further, memory corresponding to the data structure in which the collection 412 is stored may be arranged or stored in a manner that groups the embeddings and/or vectors in the collection 412 together, within the data structure. In some examples, feature vectors and their corresponding embeddings generated in accordance with mechanisms described herein may be stored for an indefinite period of time. Additionally, or alternatively, in some examples, as new feature vectors and/or embeddings are generated and stored, the new feature vectors and/or embeddings may overwrite older feature vectors and/or embeddings that are stored in memory (e.g., based on metadata of the embeddings indicating a version), such as to improve memory capacity. Additionally, or alternatively, in some examples, feature vectors and/or embeddings may be deleted from memory at specified intervals of time, and/or based on an amount of memory that is available (e.g., in the embedding object memory 310), to improve memory capacity.

Generally, the ability to store embeddings corresponding to historical plans and historical inputs allows a user to associate, locate, and/or generate new plans in a novel manner that has the benefit of being computationally efficient. Mechanisms described herein are efficient for reducing memory usage, as well as for reducing usage of processing resources to search through stored content, such as because embeddings occupy relatively little space in memory compared to alternative data objects, such as text, videos, images, etc. Additional and/or alternative advantages may be recognized by those of ordinary skill in the art.

FIG. 5 illustrates an example method 500 for retrieving information from an embedding object memory, according to some aspects described herein. In examples, aspects of method 500 are performed by a device, such as computing device 102 and/or server 104, discussed above with respect to FIG. 1.

Method 500 begins at operation 502 wherein an input is received. The input may be an input embedding, such as an input embedding that is generated by a machine-learning model. Additionally, or alternatively, the input may be a user-input that is provided to a machine-learning model to generate an input embedding, prior to receiving the input embedding.

At operation 504, a plurality of stored semantic embeddings are retrieved, based on the input. The plurality of stored semantic embeddings may be retrieved from the embedding object memory. In some examples, the plurality of stored semantic embeddings each correspond to a respective historic plan. The plurality of stored semantic embeddings may further each correspond to a respective historic input associated with a corresponding historic plan. The historic plans may include one or more executable skills.

For example, the executable skills may include at least one of a dictionary lookup operations, an expert system operation (e.g., Generate KQL, ValidateKQL), a security expert analysis (e.g., Analyze Data, Create Summary, Extract Entities, Determine Root Cause), a functional helper (e.g., Extract Type, Filter Data, Split Data, Combine Data, Combine Data and Check For Completion), and a security information and event management (SIEM) call (Execute KQL, Lookup Threat Intelligence). While several examples of executable skills are provided herein, such skills are merely examples. Additional and/or alternative types of executable skills will be recognized by those of ordinary skill in the art.

At operation 506, a subset of semantic embeddings are determined from the plurality of stored semantic embeddings based on a similarity to the input. In some examples, the subset of semantic embeddings are further determined based on a personalization to at least one of a user or organization. For example, the personalization may include receiving metadata that corresponds to the input embedding. The subset of semantic embeddings may be retrieved based on the similarity to the input embedding and the metadata.

In some examples, the subset of semantic embeddings may be filtered based on the personalization. For example, if the metadata indicates that a specific skill is not desirable, then semantic embeddings associated with historic plans that contain the specific skill may be filtered out (e.g., not included in the determined subset). Conversely, if the metadata indicates that a specific skill is highly desirable, then semantic embeddings associated with historic plans that contain the specific skill may be included in the determined subset of semantic embeddings.

In some examples, the metadata is associated with compliance requirements for security. The compliance requirements may be specified by the user and/or the organization to which the subset of semantic embeddings is personalized. For example, the metadata may adapt the subset of semantic embeddings to include only semantic embeddings whose associated plans are determined to be good (e.g., executed in compliance with specific security protocols). In some examples, the metadata may adapt the subset of semantic embeddings to include on semantic embeddings whose associated plans are determined to be stable within a requisite degree for measuring stability.

In some examples, the determining a subset of embeddings includes determining a respective similarity between the input embedding and each embedding of the plurality of stored semantic embeddings. In some examples, the similarities are distances (e.g., cosine distances). In some examples, operation 506 further includes determining an ordered ranking of the one or more similarities and/or that one or more of the similarities are less than a predetermined threshold. Some examples further include identifying the subset of semantic embeddings with similarities to the input embedding that are less than the predetermined threshold or based on the ordered ranking, thereby retrieving a subset of semantic embeddings from the plurality of stored semantic embeddings that is determined to be related to the input embedding.

In some examples, the input embedding and each embedding of the plurality of stored semantic embeddings are stored in a metric graph as nodes. A respective edge of the metric graph may be defined between the input embedding and each embedding of the plurality of stored semantic embeddings. Each edge may be associated with a respective distance of the distances (e.g., calculated similarities between the embeddings).

At operation 508, it is determined if there is a plan associated with the subset of semantic embeddings and the input. For example, the plan may be determined based on the subset of embeddings and the input embedding. In some examples, source data that is associated with the subset of embeddings may be located (e.g., local to a device on which method 500 is being executed and/or remote from a device on which method 500 is being executed) and the plan may be further determined based on the source data. The source data may include one or more of audio files, text files, image files, video files, threat intelligence data, security reports, log files, data generated by specific software applications, etc.

If it is determined that there is not an action associated with the subset of semantic embeddings, flow branches “NO” to operation 510, where a default action is performed. For example, the subset of semantic embeddings may have an associated pre-configured action. In other examples, method 500 may comprise determining whether the subset of semantic embeddings has an associated default action, such that, in some instances, no action may be performed as a result of the determined subset of semantic embeddings. Method 500 may terminate at operation 510. Alternatively, method 500 may return to operation 502 to provide an iterative loop of receiving an input, retrieving a plurality of stored semantic embeddings, determining a subset of semantic embeddings from the plurality of stored semantic embeddings, and determining if there is a plan associated with the subset of semantic embeddings and the input.

If however, it is determined that there is a plan associated with the subset of semantic embeddings and the input, flow instead branches “YES” to operation 512, where the plan is generated based on the subset of semantic embeddings and the input embedding. In some examples, the generated plan is a new plan that is different than the historic plans corresponding to the subset of semantic embeddings.

In some examples, the plan is generated using few-shot prompting. For few-shot prompting, pre-processing may occur for generating a plan. For example, there may be a limited number of labeled or summarized data elements (e.g., embeddings) and a prediction (e.g., the plan) may be generated based on the limited number of labeled data elements. In some examples, the plan is generated using one-shot or zero-shot prompting. For one-shot prompting, a single labeled or summarized data element and prediction may be generated. For zero-shot prompting, there may be no labels or summaries for data elements (e.g., embeddings), such that algorithms may have to make predictions about new plans by using prior knowledge about relationships that exist between data elements (e.g., embeddings).

In some examples, the new plan includes one or more skills. One or more skills of the new plan may be similar to one or more skills of the historic plans. In some examples, the new plan includes instructions that, when executed by a computing device, cause a set of operations to be performed (e.g., automatically) that correspond to the one or more skills.

At operation 514, the plan is provided as an output. For example, the plan may be provided as an output to a user, a system on which method 500 is being executed, and/or a system remote from that on which method 500 is being executed. Further in some examples, the method 500 may further include adapting a computing device to execute the plan that is provided.

The plan may be any of a plurality of different plan. For example, the plan may be a plan that is performed by a user and/or by a system. The plan may include instructions and/or information that are output to a user. Additionally, or alternatively, one or more aspects of the plan (e.g., a portion of or the entirety of the plan) may be performed automatically by a computing device (e.g., computing device 102). While particular examples of actions have been provided herein, the particular examples are merely examples. Additional and/or alternative examples should be recognized by those of ordinary skill in the art, at least in light of teachings provided herein.

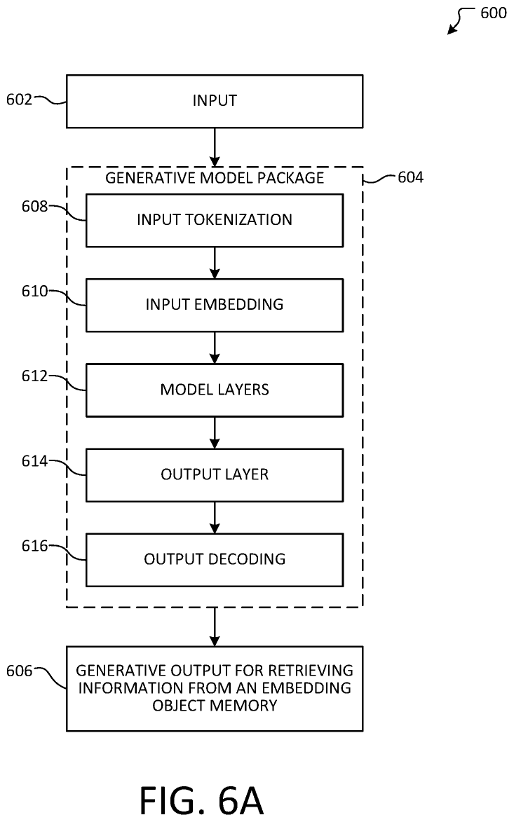

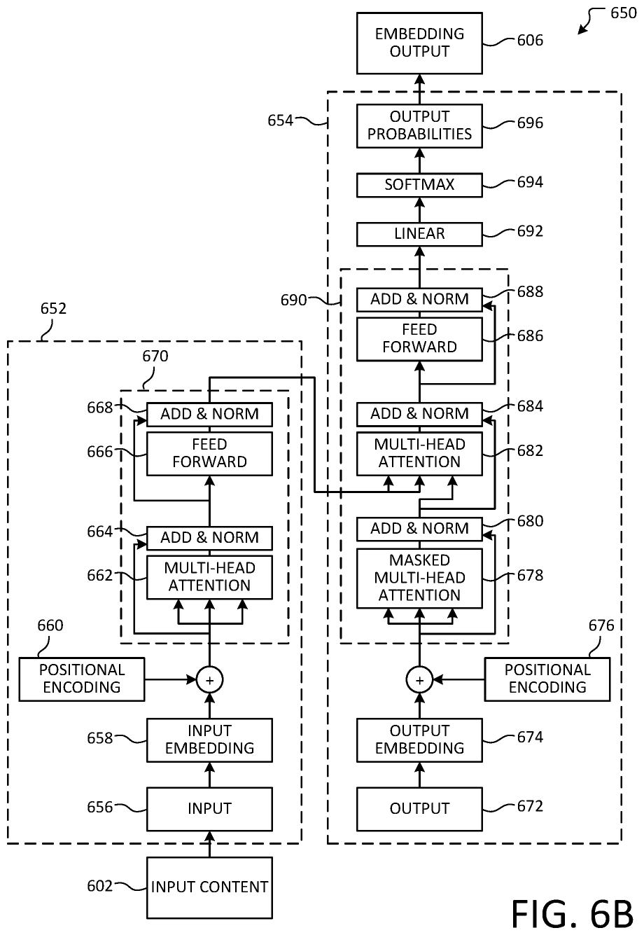

FIGS. 6A and 6B illustrate overviews of an example generative machine learning model that may be used according to aspects described herein. With reference first to FIG. 6A, conceptual diagram 600 depicts an overview of pre-trained generative model package 604 that processes an input 602 to generate model output for retrieving information from an embedding object memory 606 according to aspects described herein. Examples of pre-trained generative model package 604 includes, but is not limited to, Megatron-Turing Natural Language Generation model (MT-NLG), Generative Pre-trained Transformer 3 (GPT-3), Generative Pre-trained Transformer 4 (GPT-4), BigScience BLOOM (Large Open-science Open-access Multilingual Language Model), DALL-E, DALL-E 2, Stable Diffusion, or Jukebox.

In examples, generative model package 604 is pre-trained according to a variety of inputs (e.g., a variety of human languages, a variety of programming languages, and/or a variety of content types) and therefore need not be finetuned or trained for a specific scenario. Rather, generative model package 604 may be more generally pre-trained, such that input 602 includes a prompt that is generated, selected, or otherwise engineered to induce generative model package 604 to produce certain generative model output 606. For example, a prompt includes a context and/or one or more completion prefixes that thus preload generative model package 604 accordingly. As a result, generative model package 604 is induced to generate output based on the prompt that includes a predicted sequence of tokens (e.g., up to a token limit of generative model package 604) relating to the prompt. In examples, the predicted sequence of tokens is further processed (e.g., by output decoding 616) to yield output 606. For instance, each token is processed to identify a corresponding word, word fragment, or other content that forms at least a part of output 606. It will be appreciated that input 602 and generative model output 606 may each include any of a variety of content types, including, but not limited to, text output, image output, audio output, video output, programmatic output, and/or binary output, among other examples. In examples, input 602 and generative model output 606 may have different content types, as may be the case when generative model package 604 includes a generative multimodal machine learning model.

As such, generative model package 604 may be used in any of a variety of scenarios and, further, a different generative model package may be used in place of generative model package 604 without substantially modifying other associated aspects (e.g., similar to those described herein with respect to FIGS. 1-5). Accordingly, generative model package 604 operates as a tool with which machine learning processing is performed, in which certain inputs 602 to generative model package 604 are programmatically generated or otherwise determined, thereby causing generative model package 604 to produce model output 606 that may subsequently be used for further processing.

Generative model package 604 may be provided or otherwise used according to any of a variety of paradigms. For example, generative model package 604 may be used local to a computing device (e.g., computing device 102 in FIG. 1) or may be accessed remotely from a machine learning service. In other examples, aspects of generative model package 604 are distributed across multiple computing devices. In some instances, generative model package 604 is accessible via an application programming interface (API), as may be provided by an operating system of the computing device and/or by the machine learning service, among other examples.

With reference now to the illustrated aspects of generative model package 604, generative model package 604 includes input tokenization 608, input embedding 610, model layers 612, output layer 614, and output decoding 616. In examples, input tokenization 608 processes input 602 to generate input embedding 610, which includes a sequence of symbol representations that corresponds to input 602. Accordingly, input embedding 610 is processed by model layers 612, output layer 614, and output decoding 616 to produce model output 606. An example architecture corresponding to generative model package 604 is depicted in FIG. 6B, which is discussed below in further detail. Even so, it will be appreciated that the architectures that are illustrated and described herein are not to be taken in a limiting sense and, in other examples, any of a variety of other architectures may be used.

FIG. 6B is a conceptual diagram that depicts an example architecture 650 of a pre-trained generative machine learning model that may be used according to aspects described herein. As noted above, any of a variety of alternative architectures and corresponding ML models may be used in other examples without departing from the aspects described herein.

As illustrated, architecture 650 processes input 602 to produce generative model output 606, aspects of which were discussed above with respect to FIG. 6A. Architecture 650 is depicted as a transformer model that includes encoder 652 and decoder 654. Encoder 652 processes input embedding 658 (aspects of which may be similar to input embedding 610 in FIG. 6A), which includes a sequence of symbol representations that corresponds to input 656. In examples, input 656 includes input content 602 which may include a user-input and/or a machine-generated input, such as a prompt, a command, context, or the like.

Further, positional encoding 660 may introduce information about the relative and/or absolute position for tokens of input embedding 658. Similarly, output embedding 674 includes a sequence of symbol representations that correspond to output 672, while positional encoding 676 may similarly introduce information about the relative and/or absolute position for tokens of output embedding 674.

As illustrated, encoder 652 includes example layer 670. It will be appreciated that any number of such layers may be used, and that the depicted architecture is simplified for illustrative purposes. Example layer 670 includes two sub-layers: multi-head attention layer 662 and feed forward layer 666. In examples, a residual connection is included around each layer 662, 666, after which normalization layers 664 and 668, respectively, are included.

Decoder 654 includes example layer 690. Similar to encoder 652, any number of such layers may be used in other examples, and the depicted architecture of decoder 654 is simplified for illustrative purposes. As illustrated, example layer 690 includes three sub-layers: masked multi-head attention layer 678, multi-head attention layer 682, and feed forward layer 686. Aspects of multi-head attention layer 682 and feed forward layer 686 may be similar to those discussed above with respect to multi-head attention layer 662 and feed forward layer 666, respectively. Additionally, masked multi-head attention layer 678 performs multi-head attention over the output of encoder 652 (e.g., output 672). In examples, masked multi-head attention layer 678 prevents positions from attending to subsequent positions. Such masking, combined with offsetting the embeddings (e.g., by one position, as illustrated by multi-head attention layer 682), may ensure that a prediction for a given position depends on known output for one or more positions that are less than the given position. As illustrated, residual connections are also included around layers 678, 682, and 686, after which normalization layers 680, 684, and 688, respectively, are included.

Multi-head attention layers 662, 678, and 682 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 6B (e.g., by a corresponding normalization layer 664, 680, or 684).

Feed forward layers 666 and 686 may each be a fully connected feed-forward network, which applies to each position. In examples, feed forward layers 666 and 686 each include a plurality of linear transformations with a rectified linear unit activation in between. In examples, each linear transformation is the same across different positions, while different parameters may be used as compared to other linear transformations of the feed-forward network.

Additionally, aspects of linear transformation 692 may be similar to the linear transformations discussed above with respect to multi-head attention layers 662, 678, and 682, as well as feed forward layers 666 and 686. Softmax 694 may further convert the output of linear transformation 692 to predicted next-token probabilities, as indicated by output probabilities 696. It will be appreciated that the illustrated architecture is provided in as an example and, in other examples, any of a variety of other model architectures may be used in accordance with the disclosed aspects. In some instances, multiple iterations of processing are performed according to the above-described aspects (e.g., using generative model package 604 in FIG. 6A or encoder 652 and decoder 654 in FIG. 6B) to generate a series of output tokens (e.g., words), for example which are then combined to yield a complete sentence (and/or any of a variety of other content). It will be appreciated that other generative models may generate multiple output tokens in a single iteration and may thus use a reduced number of iterations or a single iteration.

Accordingly, output probabilities 696 may thus form embedding output 606 according to aspects described herein, such that the output of the generative ML model (e.g., which may include structured output) is used as input for determining an action according to aspects described herein (e.g., similar to the plan generator 310 of FIG. 3). In other examples, embedding output 606 is provided as generated output for executing a plan (e.g., the plan 312).

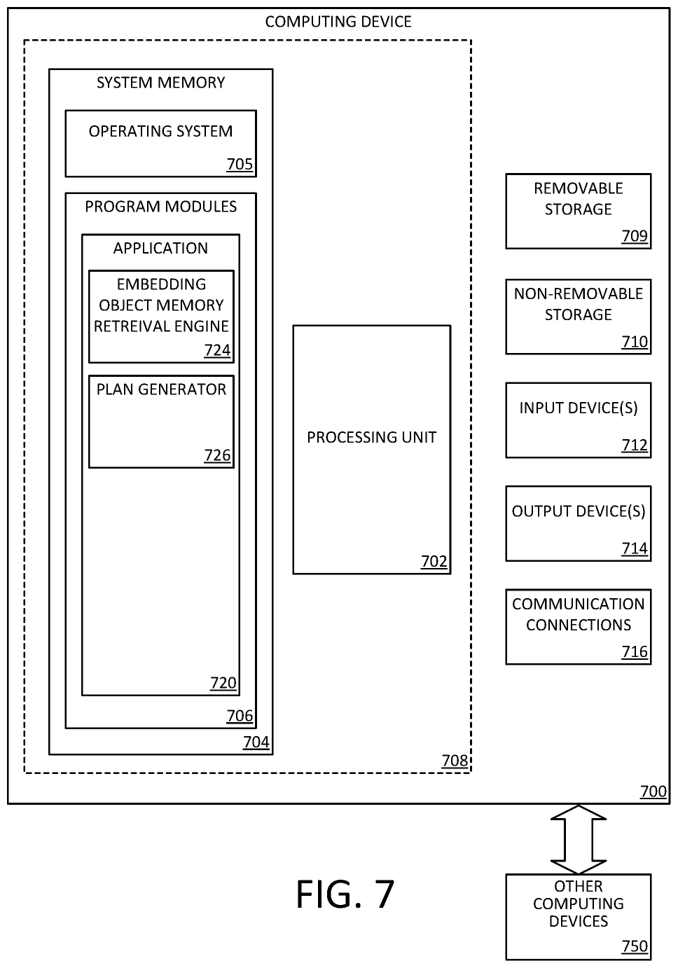

FIGS. 7-9 and the associated descriptions provide a discussion of a variety of operating environments in which aspects of the disclosure may be practiced. However, the devices and systems illustrated and discussed with respect to FIGS. 7-9 are for purposes of example and illustration and are not limiting of a vast number of computing device configurations that may be utilized for practicing aspects of the disclosure, described herein.

FIG. 7 is a block diagram illustrating physical components (e.g., hardware) of a computing device 700 with which aspects of the disclosure may be practiced. The computing device components described below may be suitable for the computing devices described above, including computing device 102 in FIG. 1. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories.

The system memory 704 may include an operating system 705 and one or more program modules 706 suitable for running software application 720, such as one or more components supported by the systems described herein. As examples, system memory 704 may store embedding object memory retrieval engine or component 724 and/or plan generator 726. The operating system 705, for example, may be suitable for controlling the operation of the computing device 700.

Furthermore, aspects of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., application 720) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Some aspects of the disclosure may also be practiced using other technologies capable of performing logical operations such as, for example, AND, OR, and NOT, including but not limited to mechanical, optical, fluidic, and quantum technologies. In addition, some aspects of the disclosure may be practiced within a general-purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

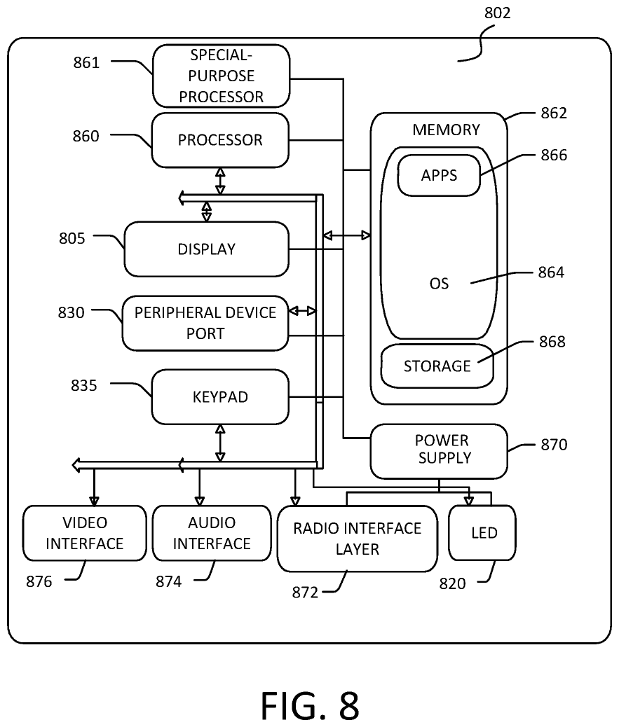

FIG. 8 is a block diagram illustrating the architecture of one aspect of a computing device. That is, the computing device can incorporate a system (e.g., an architecture) 802 to implement some aspects. In some examples, the system 802 is implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800 described herein (e.g., an embedding object memory insertion engine, an embedding object memory retrieval engine, etc.).

The system 802 has a power supply 870, which may be implemented as one or more batteries. The power supply 870 might further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via the audio transducer 825. In the illustrated example, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and/or special-purpose processor 861 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with aspects of the present disclosure, the microphone may also serve as an audio sensor to facilitate control of notifications, as will be described below. The system 802 may further include a video interface 876 that enables an operation of an on-board camera 830 to record still images, video stream, and the like.

A computing device implementing the system 802 may have additional features or functionality. For example, the computing device may also include additional data storage devices (removable and/or non-removable) such as, magnetic disks, optical disks, or tape. Such additional storage is illustrated in FIG. 8 by the non-volatile storage area 868.

Data/information generated or captured by the computing device and stored via the system 802 may be stored locally on the computing device, as described above, or the data may be stored on any number of storage media that may be accessed by the device via the radio interface layer 872 or via a wired connection between the computing device and a separate computing device associated with the computing device, for example, a server computer in a distributed computing network, such as the Internet. As should be appreciated such data/information may be accessed via the computing device via the radio interface layer 872 or via a distributed computing network. Similarly, such data/information may be readily transferred between computing devices for storage and use according to well-known data/information transfer and storage means, including electronic mail and collaborative data/information sharing systems.

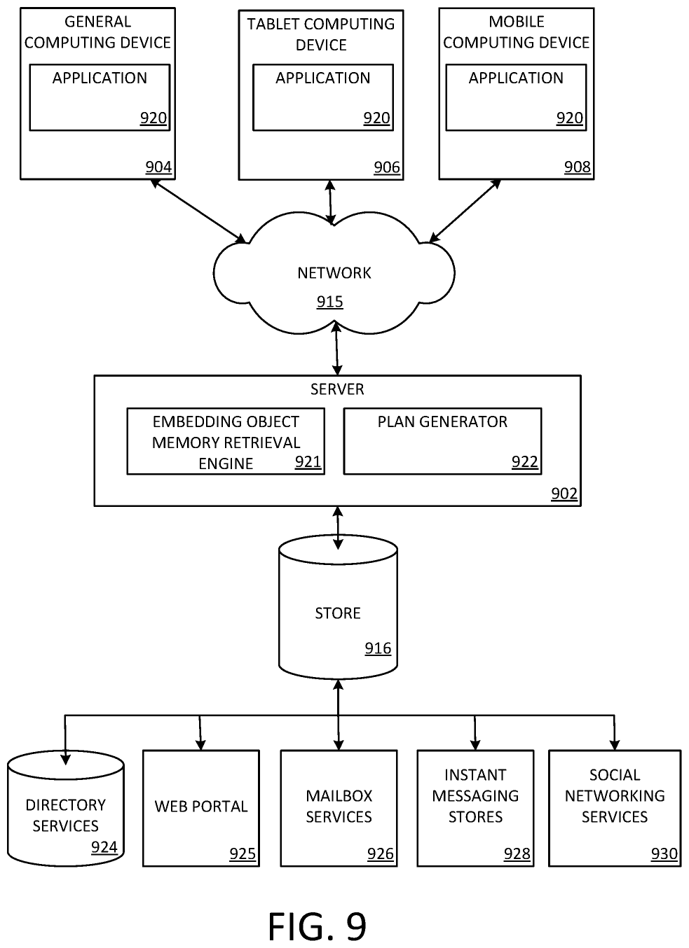

FIG. 9 illustrates one aspect of the architecture of a system for processing data received at a computing system from a remote source, such as a personal computer 904, tablet computing device 906, or mobile computing device 908, as described above. Content displayed at server device 902 may be stored in different communication channels or other storage types. For example, various documents may be stored using a directory service 924, a web portal 925, a mailbox service 926, an instant messaging store 928, or a social networking site 930.

An application 920 (e.g., similar to the application 720) may be employed by a client that communicates with server device 902. Additionally, or alternatively, embedding object memory retrieval engine 921 and/or plan generator 922 may be employed by server device 902. The server device 902 may provide data to and from a client computing device such as a personal computer 904, a tablet computing device 906 and/or a mobile computing device 908 (e.g., a smart phone) through a network 915. By way of example, the computer system described above may be embodied in a personal computer 904, a tablet computing device 906 and/or a mobile computing device 908 (e.g., a smart phone). Any of these examples of the computing devices may obtain content from the store 916, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for orchestrating an execution plan, the method comprising:
receiving an input embedding, wherein the input embedding is generated by a machine-learning model;
retrieving a plurality of stored semantic embeddings, from an embedding object memory, based on the input embedding, wherein the plurality of stored semantic embeddings each correspond to a respective historic plan, and wherein each historic plan comprises one or more executable skills;
determining a subset of semantic embeddings from the plurality of stored semantic embeddings based on a similarity to the input embedding;
generating, based on the subset of semantic embeddings and the input embedding, a new plan, wherein the new plan is different than the historic plans corresponding to the subset of semantic embeddings; and
providing the new plan as an output.

2. The method of claim 1, wherein the new plan comprises instructions that, when executed by a computing device, cause a set of operations to be performed corresponding to one or more skills.

3. The method of claim 1, wherein the plurality of stored semantic embeddings each correspond to a respective historic input and the respective historic plan.

4. The method of claim 1, wherein the subset of semantic embeddings is further determined based on a personalization to at least one of a user or organization.

5. The method of claim 4, wherein the personalization comprises:
receiving metadata corresponding to the input embedding, wherein the subset of semantic embeddings are retrieved based on the similarity to the input embedding and the metadata.

6. The method of claim 5, wherein the metadata is associated with compliance requirements for security.

7. The method of claim 1, wherein the determining a subset of embeddings comprises:
determining a respective similarity between the input embedding and each embedding of the plurality of stored semantic embeddings;
determining an ordered ranking of the one or more similarities or that one or more of the similarities are less than a predetermined threshold; and
identifying the subset of semantic embeddings with similarities to the input embedding that are less than the predetermined threshold or based on the ordered ranking, thereby retrieving a subset of semantic embeddings from the plurality of stored semantic embeddings that is determined to be related to the input embedding.

8. The method of claim 7, wherein the similarities are distances.

9. The method of claim 8, wherein the input embedding and each embedding of the plurality of stored semantic embeddings are stored in a metric graph as nodes, wherein a respective edge is defined between the input embedding and each embedding of the plurality of stored semantic embeddings, and wherein each edge is associated with a respective distance of the distances.

10. The method of claim 1, further comprising, prior to receiving the input embedding:
receiving user-input; and
generating the input embedding based on the user-input.

11. A system for orchestrating an execution plan, the system comprising:
a processor; and
memory storing instructions that, when executed by the processor, cause the system to perform a set of operations, the set of operations comprising:
receiving an input;
retrieving a plurality of stored semantic embeddings, from an embedding object memory, based on the input, wherein the plurality of stored semantic embeddings each correspond to respective historic plans, and wherein each historic plan comprises one or executable skills;
determining a subset of semantic embeddings from the plurality of stored semantic embeddings based on a similarity to the input;
generating, based on the subset of semantic embeddings and the input, a new plan, wherein the new plan is different than the historic plans corresponding to the subset of semantic embeddings; and
providing the new plan as an output.

12. The system of claim 11, wherein the input is an input embedding, and wherein the input embedding is generated by a generative multimodal machine-learning model.

13. The system of claim 11, wherein the set of operations further comprise:
adapting a computing device to execute the plan.

14. The system of claim 11, wherein the subset of semantic embeddings is further retrieved based on a personalization to at least one of a user or organization.

15. The system of claim 14, wherein the personalization comprises:
receiving metadata corresponding to the input, wherein the subset of semantic embeddings are retrieved based on the similarity to the input and the metadata.

16. The system of claim 15, wherein the metadata is associated with compliance requirements for security.

17. The system of claim 11, wherein the determining a subset of embeddings comprises:
determining a respective similarity between the input and each embedding of the plurality of stored semantic embeddings;
determining an ordered ranking of the one or more similarities or that one or more of the similarities are less than a predetermined threshold; and
identifying the subset of semantic embeddings with similarities to the input that are less than the predetermined threshold or based on the ordered ranking, thereby retrieving a subset of semantic embeddings from the plurality of stored semantic embeddings that is determined to be related to the input.

18. The system of claim 17, wherein the similarities are distances.

19. The system of claim 18, wherein the input and each embedding of the plurality of stored semantic embeddings are stored in a metric graph as nodes, wherein a respective edge is defined between the input and each embedding of the plurality of stored semantic embeddings, and wherein each edge is associated with a respective distance of the distances.

20. A method for orchestrating an execution plan, the method comprising:
receiving an input;
retrieving a plurality of stored semantic embeddings, from an embedding object memory, based on the input, wherein the plurality of stored semantic embeddings each correspond to a respective historic plan, and wherein each historic plan comprises one or more executable skills;
determining a subset of semantic embeddings from the plurality of stored semantic embeddings based on a similarity to the input;
filtering the subset of semantic embeddings based on a personalization associated with at least one of a user or organization, wherein the personalization is based on metadata associated with compliance requirements for security;
generating, based on the filtered subset of semantic embeddings and the input, a new plan, wherein the new plan is different than the historic plans corresponding to the subset of semantic embeddings; and
providing the new plan as an output.
